(19) United States
(12) Patent Application Publication
(10) Pub. No.: US 2002/0168219 A1
(43) Pub. Date: Nov. 14, 2002

(54) INTERNAL PIPE EXPANSION NUT

(76) Inventor: Chien-Cheng Wu, Chang Hua Hsien (TW)

Correspondence Address: Dougherty & Troxell, ONE SKYLINE PLACE, 5205 LEESBURG PIKE, SUITE 1404, FALLS CHURCH, VA, 22041, US

(21) Appl. No.: 09/852,637

(22) Filed: May 11, 2001

(51) Int. Cl. F16B 9/00

(52) U.S. Cl. 403/201

(57) ABSTRACT

An internal pipe expansion nut comprised of a threaded tube and a plurality of fluted washers sleeved onto the threaded tube, each fluted washer consisting of a similarly aligned and appropriately curved angular design having several intervallically disposed support elements of graduated width extending radially towards its circumference. The most important feature of the present invention is that the threaded tube is a one-piece component injection molded of a plastic compound material having internal threads inside the tube, a bevel shape at each of the two ends, and a series of locating indentations to nest the fluted washers arrayed around the exterior between the bevel shape at the two ends. The plurality of fluted washers of a similarly aligned and appropriately curved angular design have disposed along their inner circumferences a series of inwardly oriented locating inset elements such that when the fluted washers are sequentially sleeved onto the locating indentations formed between the bevel shape at the two ends of the threaded tube, the locating inset elements of the plurality of fluted washers become forcefully engaged under tension in the corresponding locating indentations. The method of fabrication provides a structure that not only facilitates expedient and rapid production, especially of the threaded tube, but also the practical and efficient unitary assembly of the threaded tube to the fluted washers.

### BACKGROUND OF THE INVENTION

1) Field of the Invention

The invention relates to an internal pipe expansion nut that provides an overall structure, especially the threaded tube section, that not only facilitates expedient and rapid volume production, but also enables the practical advantage of unitary construction during the assembly of the threaded tube and the fluted washers.

2) Description of the Prior Art

The overall structure of a conventional internal pipe expansion nut, referring to FIG. 1 and FIG. 2, is typically comprised of a threaded tube 2 with internal threads 21 and two fluted washers 3 situated at the upper and lower extremities of the said threaded tube 2; each of the two fluted washers 3 has several intervallically disposed support elements 31 of graduated width extending radially towards the outer circumference and, furthermore, the two fluted washers 3 are of a similarly aligned and appropriately curved angle, with their outer diameters fabricated slightly larger than the inner diameter of the connected pipe 4; the two ends of the said threaded tube 2 are fabricated to a relative small matching diameter and, finally, to enable the sleeving and positioning of the inner annulus 32 of the said two fluted washers 3, the outer periphery along both the top and bottom ends 22 of the threaded tube 2 are pressure punched to flare them against the inner annuli 32 of the two fluted washers 3 to achieve attachment; when the internal pipe expansion nut is sleeved into the connected pipe 4 (as shown in FIG. 2) and a bolt 5 is inserted through a superimposed pipe 6 and fastened to the threads 21 in the center of the threaded tube 2 of the said expansion nut, the graduated width and radially extending support elements 31 disposed on the two fluted washers 3 of the said expansion nut are flexed outward and distend to effectively conjoin the two pipes in a perpendicular flush arrangement.

Although the said convention internal pipe expansion nut is capable of nominally conjoining two pipes in a perpendicular flush arrangement, since the overall structural involves the assembly of the threaded tube 2 to the two fluted washers 3 and notably because the threaded tube 2 is constructed entirely of hollow metal stock, the initial production stage requires the tapping of the internal threads 21 within the threaded tube 2 as well as reducing the diameter of its two ends 22 to enable the attachment of the said two fluted washers 3 to both the upper and the lower extremities of the threaded tube 2, therefore, assembly is quite complex and, furthermore, relatively high defect rates are incurred during the lathing process; in addition, pressure punching is required to flare the outer periphery 221 of both the upper and lower extremities of the said threaded tube 2 in order to mount the two fluted washers 3 onto the threaded tube 2 and thereby complete the structure of the internal pipe expansion nut; otherwise, if the two extremities of the threaded tube 2 cannot be solidly wedged into the said two fluted washers 3, loosening occurs after the internal pipe expansion nut so assembled is sleeved into the connected pipe 4; as such, the fabrication as well as the assembly of the entire structure is overly complicated and impractical, and awaits improvement

Therefore, the inventor of the invention herein addressed the shortcomings and less than ideal aspects of the said conventional internal pipe expansion nut, enhancing the structure with further improvements, while preserving any existent advantages.

### SUMMARY OF THE INVENTION

The primary objective of the invention herein is to provide an internal pipe expansion nut in which the threaded tube is a one-piece component injection molded of a plastic compound material enabling the forming of internal threads inside the tube, a bevel shape at each of the two ends, and a series of locating indentations to nest the fluted washers arrayed around the exterior between the bevel shape at the two ends; a plurality of fluted washers consisting of a similarly aligned and appropriately curved angular design having disposed along their inner circumferences a series of inwardly oriented locating inset elements such that when the said fluted washers are sequentially sleeved onto the locating indentations formed between the bevel shape at the two ends of the threaded tube, the locating inset elements of the said fluted washers become forcefully engaged under tension in the corresponding locating indentations; as such, the method of structural fabrication facilitates expedient and rapid production, specifically practical and efficient unitary construction during the assembly of the threaded tube to the fluted washers.

The structural features, operation, and other aspects of the present invention are elaborated by the brief description of the drawings below and followed by the detailed description of the invention for purposes of examination and reference.

### BRIEF DESCRIPTION OF THE DRAWINGS

FIG. 1 is an orthographic and cross-sectional drawing of a conventional structure.

FIG. 2 is an isometric drawing of the conventional structure

FIG. 3 is an exploded drawing of the invention herein (equipped with two fluted washers).

FIG. 4 is an isometric cross-sectional drawing of the invention herein (equipped with two fluted washers).

FIG. 5 is a cross-sectional drawing of the invention herein (equipped with two fluted washers).

FIG. 6 is an exploded drawing of another embodiment of the invention herein (equipped with three fluted washers).

FIG. 7 is an isometric cross-sectional drawing of another embodiment of the invention herein (equipped with three fluted washers).

FIG. 8 is a cross-sectional drawing of another embodiment of the invention herein (equipped with three fluted washers).

FIG. 9 is an exploded drawing of another embodiment of the invention herein (equipped with four fluted washers).

FIG. 10 is an isometric cross-sectional drawing of another embodiment of the invention herein (equipped with four fluted washers).

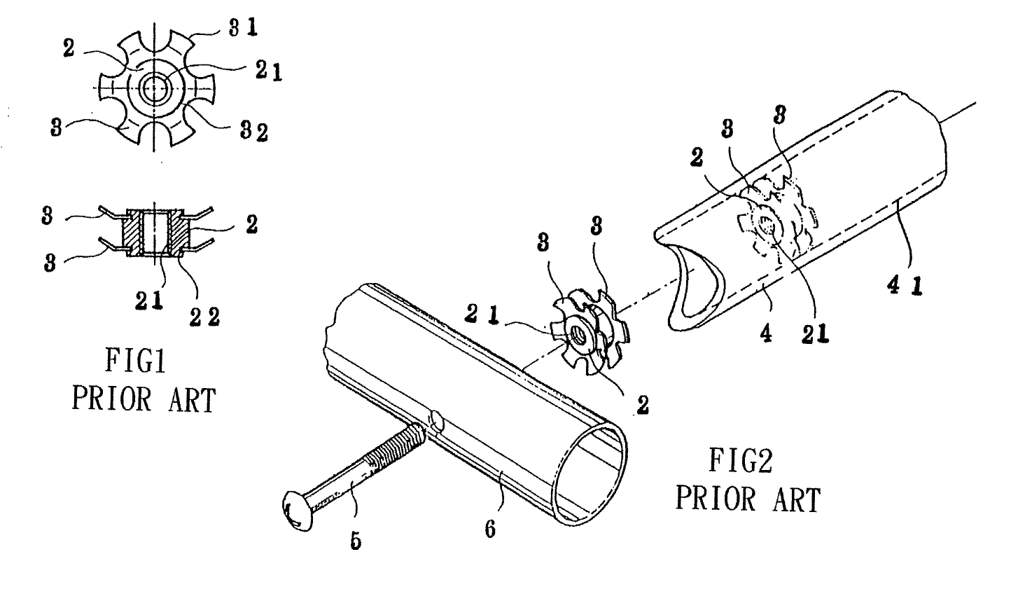

### DETAILED DESCRIPTION OF THE INVENTION

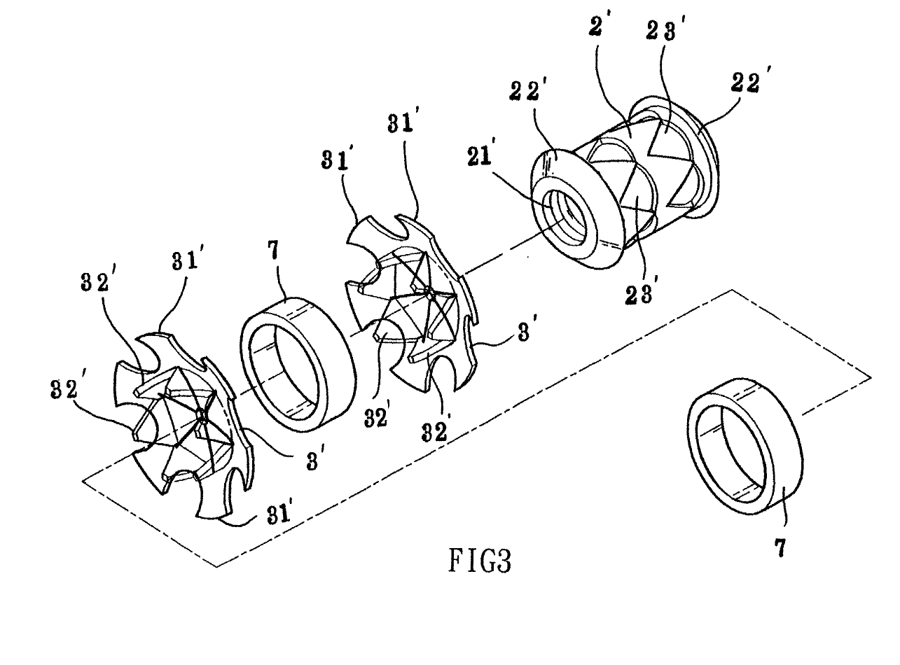

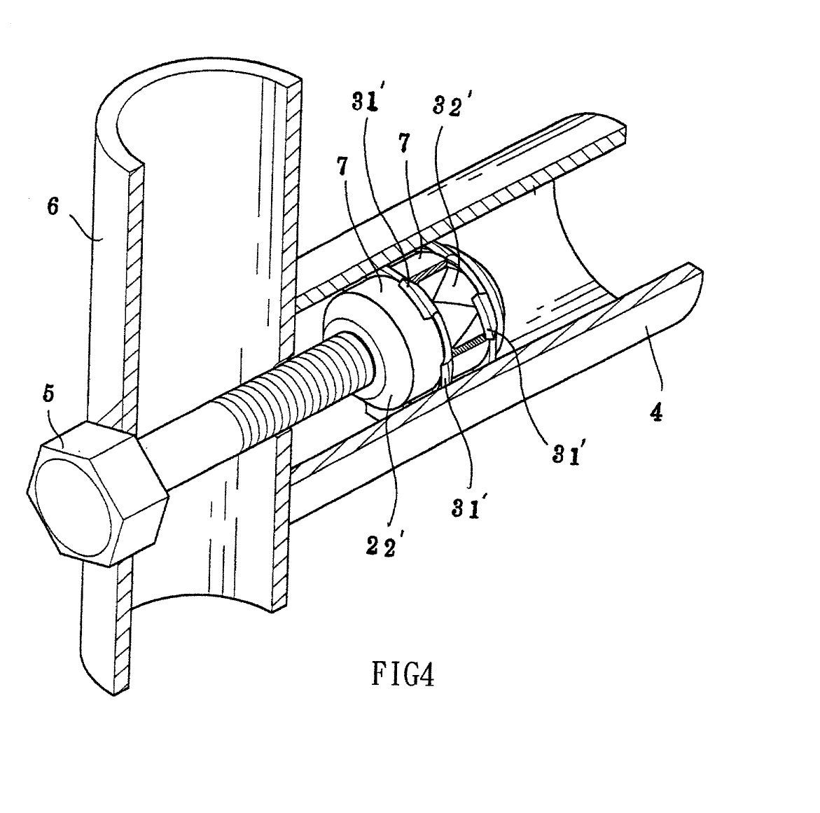

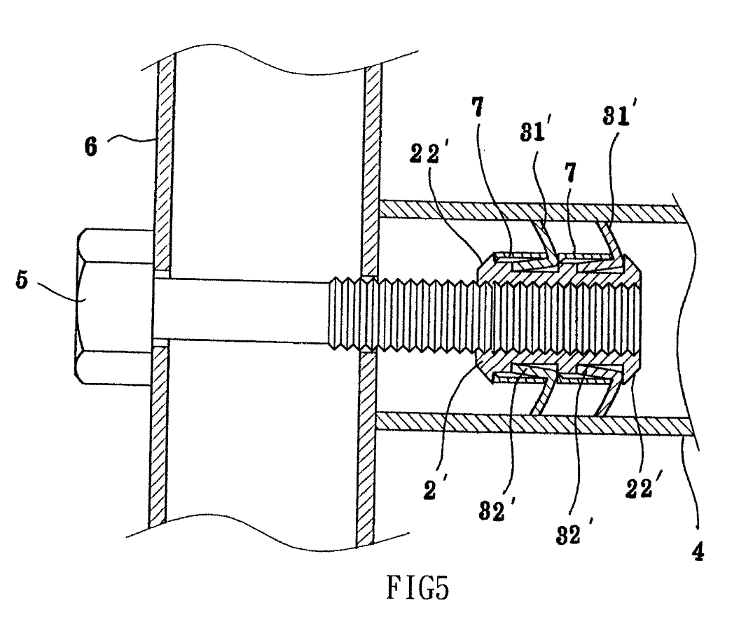

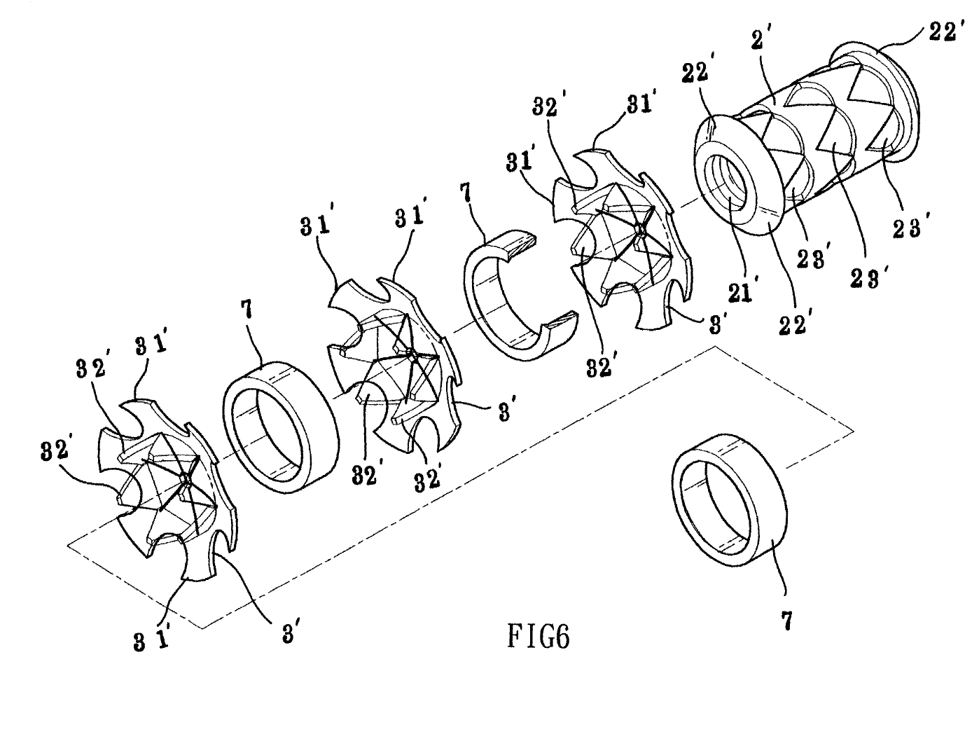

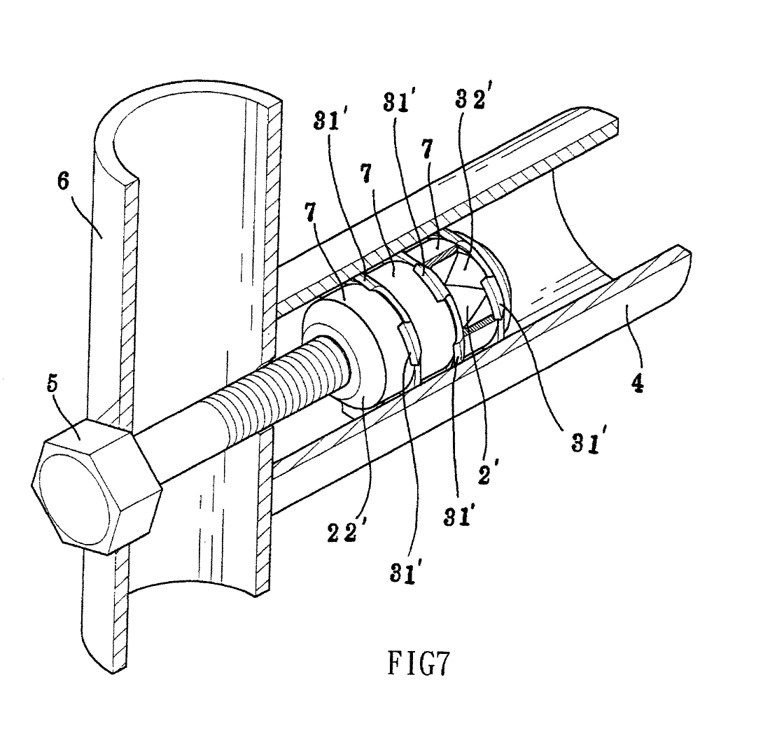

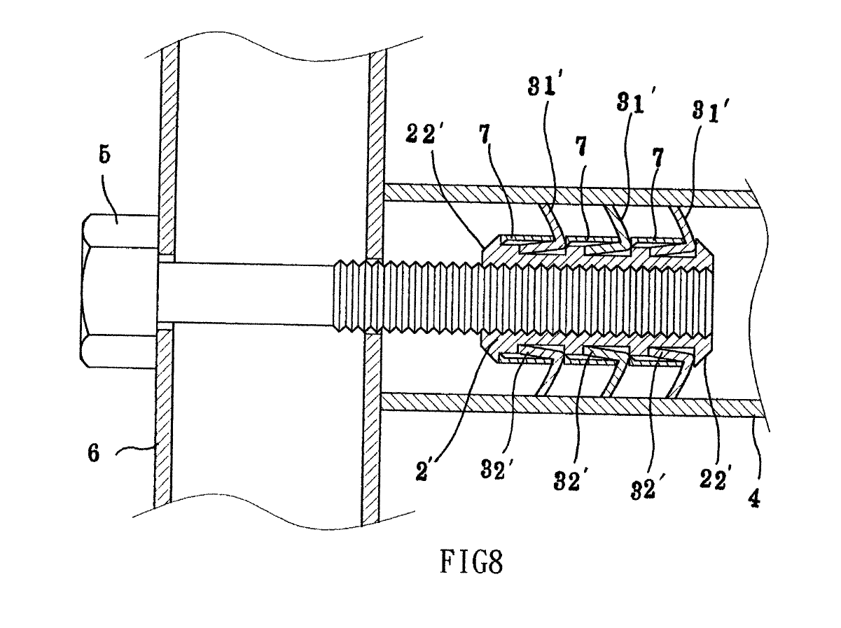

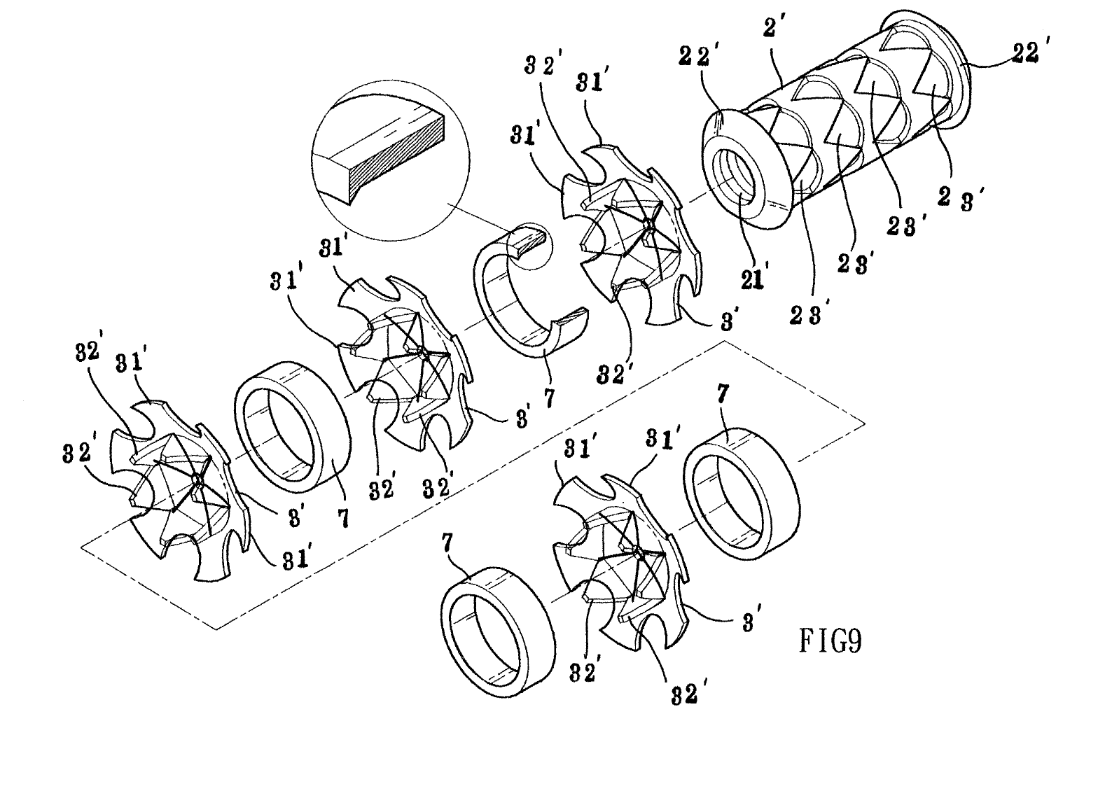

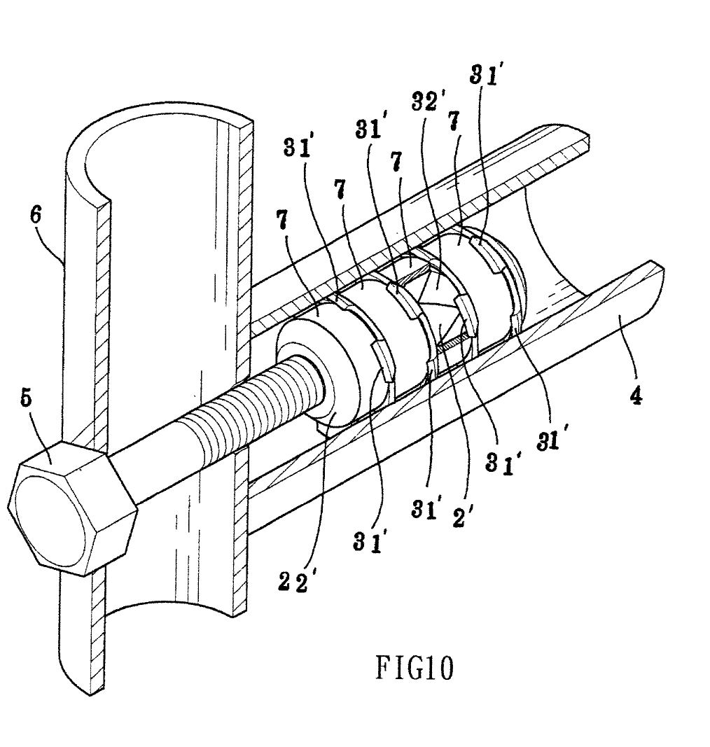

Referring to FIG. 3, FIG. 4, FIG. 5, FIG. 6, FIG. 7, FIG. 8, FIG. 9, and FIG. 10, the internal pipe expansion nut of the invention herein is comprised of a threaded tube 2′ and a plurality of fluted washers 3′ sleeved onto the threaded tube 2′, each fluted washer 3′ consisting of a similarly aligned and appropriately curved angular design having several intervallically disposed support elements 31? of graduated width extending radially towards its circumference; the most important feature of the present invention is that the threaded tube 2′ is a one-piece component injection molded of a plastic compound material having internal threads 21′ inside the tube, a bevel shape 22′ at each of the two ends, and a series of locating indentations 23′ to nest the fluted washers 3′ arrayed around the exterior between the bevel shape 22′ at the two ends; the plurality of fluted washers 3′ consisting of a similarly aligned and appropriately curved angular design having disposed along their inner circumferences a series of inwardly oriented locating inset elements 32′ such that when the said fluted washers 3′ are sequentially sleeved onto the locating indentations 23′ formed between the bevel shape 22′ at the two ends of the threaded tube 2′, the locating inset elements 32′ of the said fluted washers 3′ become forcefully engaged under tension in the corresponding locating indentations 23′.

In the said structural assembly, since the structural features of the entire threaded tube 2′, including the internal threads 21′ inside the tube and the series of locating indentations 23′ nesting the fluted washers 3′ arrayed around the exterior between the bevel shape 22′ at the two ends are all injection molded of a plastic compound material at the initial production stage, the overall quality of the structural components is stable and rapid volume production is facilitated; furthermore, since the fluted washers 3′ are constructed of a rigid metal material and the series of inwardly oriented locating inset elements 32′ along their inner circumferences are disposed during the initial production stage, when sequentially sleeved onto the threaded tube 2′ between the bevel shape 22′ at the two ends, the gently curved planar shape of the locating inset elements 32′ on the said fluted washers 3′ enable them to become forcefully engaged under tension in the corresponding locating indentations 23′ formed between the bevel shape 22′ at the two ends of the threaded tube 2! without linear intrusion into the one- piece injection molded threaded tube 2′ and, given their rigid metal construction, the said enmeshing locating elements 32′ are capable of flexile insertion and secure positioning into the corresponding locating indentations 23′ due to their gently curved planar shape and effectively assembled to the threaded tube 2′ and thereby complete the internal pipe expansion nut of the present invention; the internal pipe expansion nut so assembled is capable of being firmly and, furthermore, evenly sleeved into a connected pipe 4 by inserting a bolt 5 through a superimposed pipe 6 and fastening it to the internal threads 21′ at the center of the threaded tube 2′ of the said expansion nut such that during the flexile outward distention of the intervallically disposed support elements 31′ of graduated width extending radially towards the outer circumference of the fluted washers 3′ of the said expansion nut, the rigid metal construction fluted washers 3′ arid their locating inset elements 32′ disposed along their inner circumferences do not linearly intrude into the plastic construction threaded tube 2′, thereby achieving an optimal perpendicular flush conjoinment.

In addition, referring to FIG. 3, FIG. 6, and FIG. 9, the locating indentations 23′ formed between the bevel shape 22′ at the two ends of the threaded tube 2′ can be arrayed in a crisscross design such that when the plurality of fluted washers 3′ are sequentially sleeved onto the corresponding locating indentations 23′ to achieve the flexile insertion and durable positioning of their locating inset elements 32′ disposed along their inner circumferences into the corresponding locating indentations 23′, the rigid metal construction and outwardly oriented curved angular design of the several intervallically disposed support elements 31′ of graduated width extending radially towards from the outer circumference of the fluted washers 3′ can be augmented in application, wherein the support elements 31′ disposed along the outer circumference of one fluted washer 3′ are situated in an overlapped arrangement with the support elements 31′ disposed along the circumference of another fluted washer 3′ and, therefore, when the internal pipe expansion nut is sleeved into the connected pipe 4 and the bolt 5 is inserted through the superimposed pipe 6 and fastened to the threaded tube 2′ of the expansion nut, the said two pipes are effectively conjoined in a further optimized perpendicular flush configuration as the support elements 31′ of graduated width extending radially towards the outer circumference of both fluted washers 31′ are brought into a state flexile outward distention.

Referring to FIG. 3, FIG. 5, FIG. 6, FIG. 8, and FIG. 9, when the plurality of fluted washers 3′ are sequentially sleeved from one extremity onto the locating indentations 23′ formed between the bevel shape 22′ at the two ends of the threaded tube 2′ and the locating inset elements 32′ disposed on the said fluted washers 3′ engage the corresponding locating indentations 23′ to achieve flexile insertion and durable positioning, a fixing ring 7 is placed between each fluted washer 3′ such that when the locating inset elements 32′ disposed along the inner circumferences of each fluted washer 3′ engage the corresponding locating indentations 23′ around the circumference of the threaded tube 2′, this effectively limits the position of more than one tier of locating inset elements 32′.

Referring again to FIG. 3, FIG. 6, and FIG. 9, when the internal pipe expansion nut of the invention herein is sleeved into the connected pipe 4 and the bolt 5 is inserted through the superimposed pipe 6 and fastened to the threaded tube 2′ of the expansion nut, the fluted washers 3″ and locating indentations 23′ of the internal pipe expansion nut can be increased in quantity to meet actual requirements and thereby provide for the further optimized perpendicular flush conjoinment of the two pipes.

In summation of the foregoing section, since the invention herein is of greater simplicity and utility than its conventional counterpart and provides an overall structure that not only facilitates expedient and rapid volume production, but also enables the practical advantage of unitary construction during the assembly of the threaded tube 2′ and the fluted washers 3′, the present invention meets new patent application requirements and is submitted to the patent bureau for review and the granting of the commensurate patent rights.

1. An internal pipe expansion nut comprised of a threaded tube and a plurality of fluted washers sleeved onto the said threaded tube, each said fluted washer consisting of a similarly aligned and appropriately curved angular design having several intervallically disposed support elements of graduated width extending radially towards the outer circumference; the most important feature of the present invention is that the said threaded tube is a one-piece component injection molded of a plastic compound material having internal threads inside the said tube, a bevel shape at each of the two ends, and a series of locating indentations to nest the said fluted washers arrayed around the exterior between the said bevel shape at the two ends; the plurality of said fluted washers consisting of a similarly aligned and appropriately curved angular design having disposed along their inner circumferences a series of inwardly oriented locating inset elements such that when the said fluted washers are sequentially sleeved onto the said locating indentations formed between the said bevel shape at the two ends of the said threaded tube, the said locating inset elements of the said plurality of fluted washers become forcefully engaged under tension in the corresponding said locating indentations; the said fabrication method provides a structure that not only facilitates expedient and rapid production, especially of the said threaded tube, but also the practical and efficient unitary assembly of the said threaded tube to the said fluted washers.

2. As mentioned in claim 1 of the internal pipe expansion nut of the invention herein, the said locating indentations formed between the said bevel shape at the two ends of the said threaded tube can be arrayed in a crisscross design such that when the said locating inset elements disposed along their inner circumferences of the said fluted washers achieve flexile insertion and durable positioning in the said locating indentations, the intervallically disposed said support elements extending radially towards from the outer circumference of the said fluted washers are augmented in application, wherein the said support elements disposed along the outer circumference of one said fluted washer are situated in an overlapped arrangement with the said support elements disposed along the outer circumference of another said fluted washer and, therefore, when the internal pipe expansion nut of the present invention is sleeved into a connected pipe and a bolt is inserted through a superimposed pipe and fastened to the said threaded tube of the said expansion nut, the said two pipes are effectively conjoined in a further optimized perpendicular flush configuration.

3. As mentioned in claim 1 of the internal pipe expansion nut of the invention herein, when the plurality of said fluted washers are sequentially sleeved from one extremity onto the said locating indentations formed between the said bevel shape at the two ends of the said threaded tube and the said locating inset elements disposed on the said fluted washers engage the corresponding said locating indentations to achieve their flexile insertion and durable positioning, a fixing ring is placed between each said fluted washer such that when the said locating inset elements disposed along the inner circumferences of each said fluted washer engage the corresponding said locating indentations around the circumference of the said threaded tube, this effectively limits the position of more than one tier of said locating inset elements.

4. As mentioned in claim 1 of the internal pipe expansion nut of the invention herein, when the internal pipe expansion nut is sleeved into the said connected pipe and the said bolt is inserted through the said superimposed pipe and fastened to the said threaded tube of the expansion nut of the present invention, the said fluted washers and the said locating indentations of the internal pipe expansion nut can be increased in quantity to meet actual requirements and thereby provide for the further optimized perpendicular flush conjoinment of the said two pipes.
